(19) United States
(12) Patent Application Publication
(10) Pub. No.: US 2016/0172833 A1
(43) Pub. Date: Jun. 16, 2016

(54) HOUSING FOR ELECTRICAL APPLIANCES

(71) Applicant: Nir VELOZNY, Tel Aviv (IL)

(72) Inventor: NIR VELOZNY, TEL AVIV (IL)

(21) Appl. No.: 14/909,744

(22) PCT Filed: Aug. 4, 2014
(86) PCT No.: PCT/IL2014/050703

§ 371 Date: Feb. 3, 2016

Related U.S. Application Data
(60) Provisional application No. 61/862,103, filed on Aug. 5, 2013.
(60) Provisional application No. 61/910,118, filed on Nov. 29, 2013.

(51) Int. Cl. H02G 3/12

(52) U.S. Cl. CPC H02G 3/12

(57) ABSTRACT

The present invention pertains to housings, which are universally configured to accommodate electrical appliances and methods of installing such housings. In particular the universal housing comprises a cylindrical component comprises a cylindrical component configured to drill through and fix to a construction part of a building, where the cylindrical component creates a space within the construction part of a building, and the space is configured to accommodate an electrical appliance, and a housing configured to reversibly couple directly or indirectly within the cylindrical component and accommodate the electrical appliance. The invention also provides drilling means configured to introduce the cylindrical component into a construction part of a building, where the drilling means comprise a drilling adapter configured to reversibly couple to and lock within the cylindrical component and a drilling head configured to reversibly couple to and lock within the drilling adapter.

### TECHNICAL FIELD

The present invention pertains to housings for electrical appliances. Particularly, the present invention pertains to housings, which are universally configured to accommodate electrical appliances and methods of installing such housings.

### BACKGROUND OF THE INVENTION

Housings for electrical appliances serve a double purpose. They are used to accommodate and protect electrical appliances and conceal their wirings, which connect the appliances to the grid. Currently available housings suffer from two main disadvantages. Each type of housing is customized for a particular type of appliances, for example, light bulbs, switches and plugs. Secondly, these housings usually extend outwardly, creating bumps and spoiling the smooth surface of a wall or ceiling. Solutions for the second disadvantage are provided as embedded housings within a wall or ceiling. However, these are also customized for a particular type of appliance.

The objective of the present invention is, therefore, to provide universal housings, configured to accommodate a plurality of types of electrical appliances.

It is still another objective of the present invention to provide universal housings embedded in a wall, ceiling or any other construction part of a building.

Still another objective of the present invention is to facilitate a method of installing universal housings in any construction part of a building in an easy, simple and user-friendly method.

This and other objectives of the present invention will become apparent as the description proceeds.

### SUMMARY OF THE INVENTION

In one aspect, the present invention provides universal housings configured to accommodate a plurality of types of electrical appliances. Such housings are basically independent of a particular appliance or its positioning within them. Accordingly, they define a space within a construction part of a building, where such space is sufficient for installing electrical appliances. Further, the different components of such universal housings are configured to achieve the desired position of any appliance by coupling with and locking to each other.

Accordingly, in one embodiment, the present invention provides a universal cylindrical component configured to be inserted into a construction part of a building, e.g., wall or ceiling, and define a space and structure designed to accommodate another component that encloses an electrical appliance.

In still one particular embodiment, the cylindrical component comprises:

a cylindrical body;
means configured to define the desirable space by directly drilling the cylindrical component into a construction part of a building;
anchoring arrangement protruding from an outer surface of the cylindrical body and configured for stronger hold of the cylindrical component to the construction part of a building;
wall interface extending horizontally relative to the main body and configured to fix the cylindrical component in place; and
one or more tool interfaces for reversible coupling with and locking to drilling means and housings of electrical appliances.

The introduction of the cylindrical component into a construction part of a building requires particular configuration of drilling tools. The present invention, therefore, also provides drilling means configured to introduce the cylindrical component into a construction part of a building, where the drilling means comprise:

drilling adapter configured to reversibly couple to and lock within the cylindrical component; and
drilling head configured to reversibly couple to and lock within the drilling adapter.

In still another particular embodiment, the drilling adapter comprises:

L-shaped channels configured to reversibly couple and lock to the tool interfaces of the cylindrical component;
a hollow cubic space within the drilling adapter configured to accommodate a cubic fitting head of the drilling head; and
clamps in opposite sides of the hollow cubic space, where the clamps are configured to lock the cubic fitting head down within the hollow cubic space.

In one particular embodiment, the drilling head comprises:

a drill bit comprising a limited number of twists;
a smooth part continuous with the drill bit;
a cubic fitting head continuous with the smooth part and configured to be inserted within
a cubic space within the drilling adapter; and
a shank continuous with the cubic fitting head.

The third component of the present invention comprises housing for electrical appliance, where such housing is configured to reversibly couple within the cylindrical component. Alternatively, the housing for an electrical appliance is configured to reversibly couple within adapting ring, which is reversibly coupled within the cylindrical component. In this alternative, an adapting card is used, which is configured to reversibly couple the adapting ring to the cylindrical component and the housing of electrical appliance to the adapting ring.

The adapting ring is particularly used when orientation of the electrical appliance is required relative to the cylindrical component or its connection with an extension or another electrical appliance. For example, a USB device is embedded in a housing, which is coupled within the adapting ring. The adapting ring is coupled within the cylindrical component and the housing of the USB device coupled within the adapting ring and may be turned within it and oriented horizontally.

For appliances that do not require particular orientation in space such as light bulbs the coupling with the cylindrical component is sufficient.

In accordance with the aspects and embodiments of the invention outlined above, the present invention provides a kit for installing electrical appliances in a construction part of a building, where the kit comprises:

cylindrical component configured to define a space within a construction part of a building and reversibly couple and lock to housings of electrical appliances;
housing for electrical appliances configured to accommodate an electrical appliance and reversibly couple within and lock to the cylindrical component;
drilling adapter configured to couple within and lock to the cylindrical component; and
drilling head configured to couple within and lock to the drilling adapter.

Additionally, the kit may further comprise:

adapting ring configured to couple within and lock to cylindrical body of the cylindrical component; and
adapting card configured to couple with the adapting ring and lock the ring to the cylindrical body and couple with housing of an electrical appliance and lock the housing within the adapting ring.

To this end, the cylindrical component comprises a serrated edge at its distal perimeter, where the serrations of the distal edge are configured to have sufficient resistance and strength to drill into a construction part of a building. Further, the cylindrical component comprises an anchoring arrangement protruding from the outer surface in proximity to the proximal edge of the cylindrical component. The proximal edge of the cylindrical component comprises a wall interface extending horizontally relative to the cylindrical body and fixing the cylindrical component to the construction part of a building, e.g. wall or ceiling.

The cylindrical component may be made of stainless steel or any other suitable metal, a polymer, or a composite material. If made of metal, it may be coated with paint, which electrically insulates it and protects it from corrosion. It is made of a single piece, and may be formed by any suitable process, such as casting or injection molding.

The following will describe particular and non-limiting examples of the present invention with reference to the drawings without departing from the scope and spirit of the present invention.

### BRIEF DESCRIPTION OF THE DRAWINGS

FIGS. 1-9 illustrate different perspectives and positions of a cylindrical component and drilling means;

FIGS. 10-16 illustrate different parts and positions of adapting means for adapting and orienting a housing of electrical appliance;

FIGS. 17-21 illustrate housing of electrical appliance configured to couple directly within a cylindrical component;

FIGS. 22-27 illustrate housing of electrical appliance configured to couple within adapting ring;

FIGS. 28-29 illustrate universal platform for handling housings of electrical appliances.

### DETAILED DESCRIPTION OF THE DRAWINGS

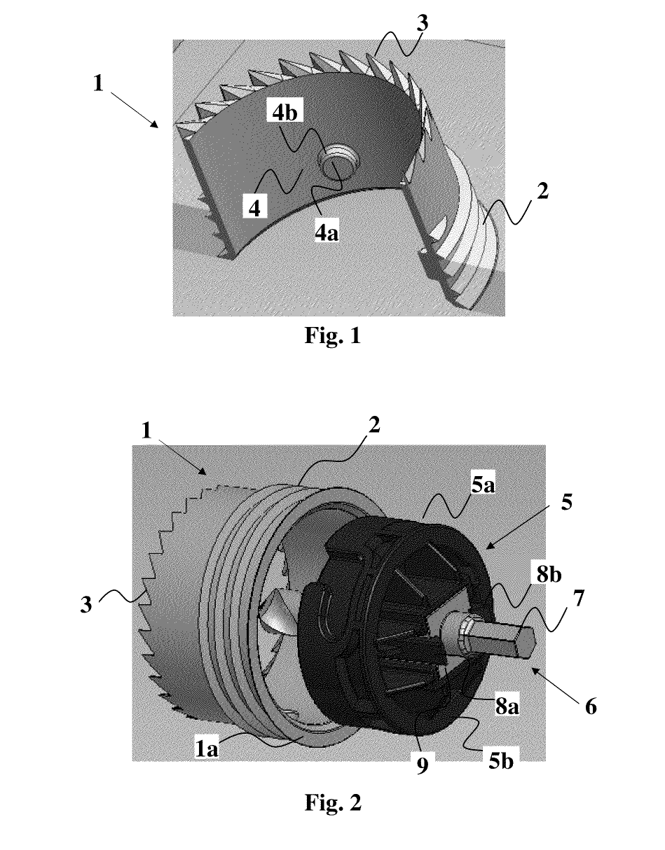

FIG. 1 illustrates a perspective view of a cross section of a cylindrical component (1). The main parts include serrations (3) extending away from the distal perimeter of the cylindrical component (1), anchoring arrangement (2) in the form of a left-hand screw at the lower part of the outer surface of the cylindrical component (1) and tool interface (4) extending from the inner surface of the cylindrical component (1). The serrations (3) are configured as partially tilted pyramids, better suitable to overcome the resistance of a construction part of a building such as a wall or ceiling to the drilling operation of the cylindrical component (1). It is possible that the serrations (3) are worn down in the drilling operation. However, once the drilling is complete and the cylindrical component (1) is fixed in place, then the serrations (3) have completed their task and remain as extensions of the cylinder body of the cylindrical component (1). Further, the serrations (3) may be formed sufficiently small such that a suitable smooth hole is cut thereby in the drilling operation. Alternatively, the serrations (3) may be formed with a razor edge (not illustrated), or any other suitable cutting arrangement.

The anchoring arrangement (2) is in the form of a left-hand screw designed to lodge the cylindrical component (1) within a construction part of a building more firmly. The level differences between the turns of the screw and the outer surface of the cylinder of the cylindrical component (1) generate better hold within the construction part of a building such as wall or ceiling. For example, a stronger pulling force has to be applied on a cylindrical component (1) with anchoring arrangement (2) in order to overcome the resistance generated by a those parts of a wall in between the turns of the screw formation of the anchoring arrangement (2). The number of turns of the anchoring arrangement (2) is sufficient to provide strong hold to the wall when the cylindrical component (1) is rotated around its axis passing through the hollow enclosure it closes and drilled into the wall.

Tool interface (4) is provided on the inner surface of the cylinder body of the cylindrical component (1). The tool interface (4) is illustrated as a shallow cylindrical member. The cylindrical members may be substantially identical to one another. They may be evenly circumferentially distributed around the inner wall of the main body and disposed at the same axial locations as one another.

The tool interface (4) is designed to cooperate with corresponding interface of drilling adapter, housing of electrical appliances and adapting ring (described below) to rotate the cylindrical component (1) in tandem with them. According to one embodiment, the tool interface (4) comprises a low cylindrical member (4b) protruding from the inner surface of the cylinder of the cylindrical component (1) and a flat top side (4a) generally parallel to the inner surface of the cylinder body of the cylindrical component (1).

A sufficient number of tool interfaces (4), two, three, or more, may be provided so that the power necessary to bore through the wall can be distributed among them without causing their mechanical failure. Further, the tool interfaces (4) are substantially identical to one another, with the same axial height and diameter. In addition, they are evenly circumferentially distributed around the inner surface of the cylinder of the cylindrical component (1), and disposed at the axial locations as one another. This arrangement ensures that the drilling adapter (5) (described below) can cooperate with any one of the tool interfaces (4) during use.

As illustrated in FIG. 2, there is provided a drilling adapter (5) configured to cooperate with the cylindrical component (1) to rotate it, thereby facilitating its installation in a wall. The drilling adapter (5) comprises a drum (5a) and a radial support (5b).

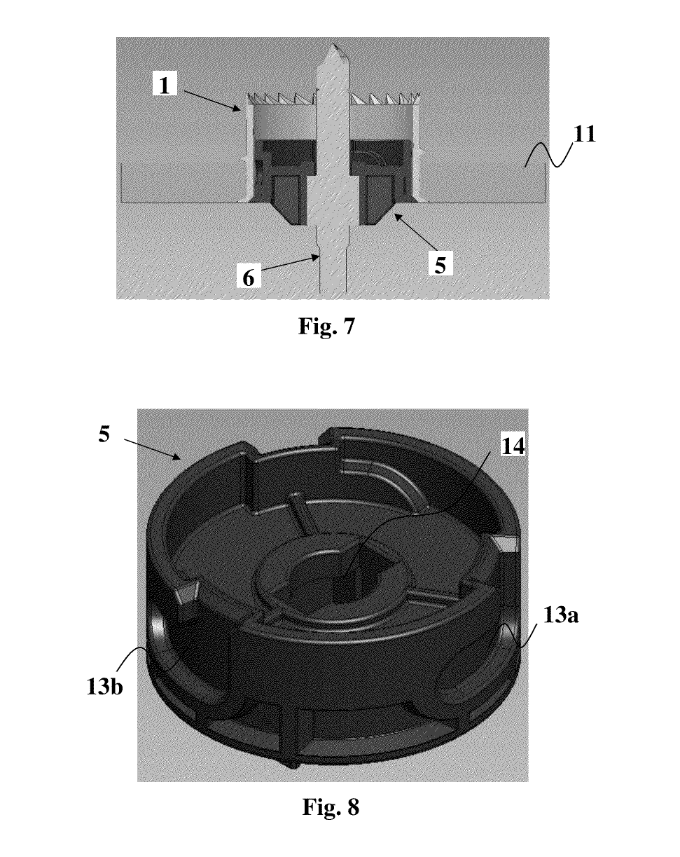

The drum (5a) is designed to interface with the cylinder body of the cylindrical component (1) to impart rotational motion thereto. An outer surface of the drilling adapter (5) interfaces with the outer surface of the cylinder body of the cylindrical component (1). These surfaces are designed to couple with each other by applying coupling means with tool interfaces (4) in the cylindrical component (1) and channels (13a, 13b) (seen better in FIG. 8) in the drilling adapter. These channels (13a, 13b) are L-shaped formed configured with vertical ingress width suitable to insert the interface tool (4), and horizontal retention portion configured to conveniently accommodate the tool interface (4) and provide sufficient friction to lock the drilling adapter (5) to the cylindrical component (1) when drilling it into a wall. The depth of the channels (13a, 13b) is sufficient so as to allow the drum (5a) to be received within the cylindrical component (1) when the tool interfaces (4) and channels (13a, 13b) engage with one another.

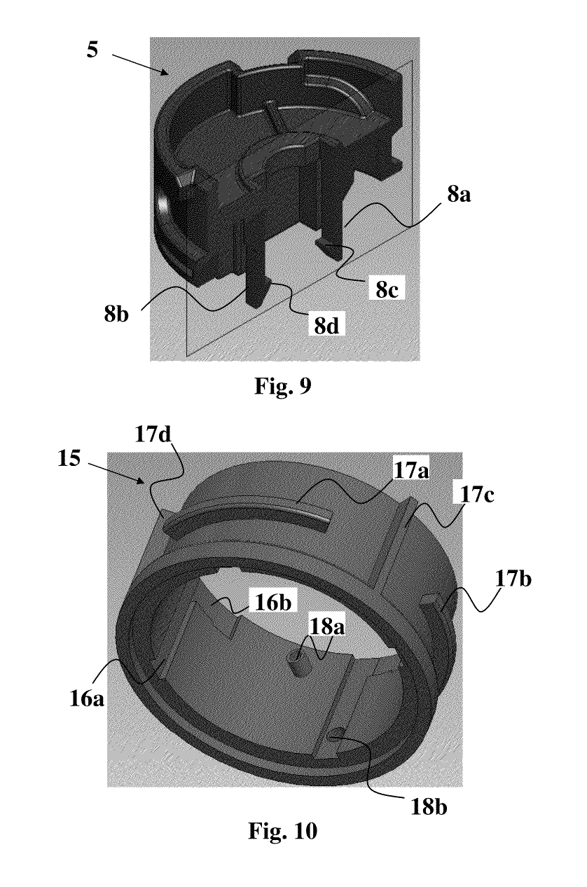

The drilling means further comprise a drill head (6), which comprises drill bit (10), shank (7) and fitting head (9) (see FIGS. 2 and 4). The twist of the drill bit (10) is only partially extending from top, usually one twist, configured to form a pilot hole in the wall and advance drilling without damaging a wall or ceiling (11 in FIG. 4) into which it drills. The remaining length of the drill bit (10) is smooth. The shank (7) is configured to match a chuck of a drill. The fitting head (9) is shaped as a cube configured to lock to the drilling adapter, i.e. drum, (5) with clamps (8a, 8b in FIG. 2) extending outwardly from the drilling adapter (5). The cube (9) is fit to be inserted into a hollow cubic space (14 in FIG. 8), the clamps (8a, 8b) locking it down and preventing it from jumping out during the drilling operation. The holding down of the fitting head (9) with the clamps is made possible with heads (8c, 8d in FIG. 9 showing a cross section of the drilling adapter, 5).

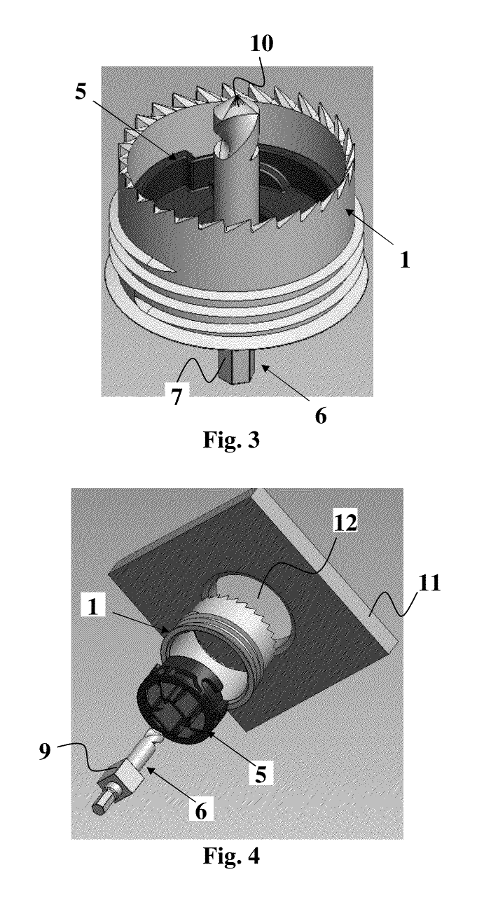

FIG. 3 shows drilling adapter (5) introduced into the cylindrical component (1) and locked within and the drilling head (6) locked in the drilling adapter (5). The locking of the drilling adapter (5) to the cylindrical component (1) enables rotating the cylindrical component around its axis, thereby generating a drilling force by the serrations (3). The head (10) and shank (7) of the drilling head protrude out of the space defined by the drilling component (1), enabling drilling the pilot hole in a wall before the serrations come in contact with it at one side and connect to a chuck of drill at the other side.

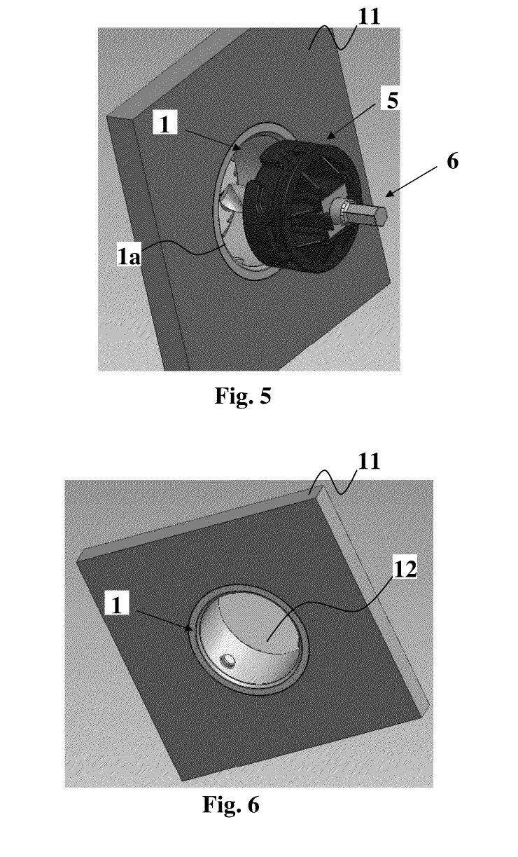

FIG. 7 shows a cross section of the locking of the drilling adapter (5) and drill head (6) within the cylindrical component (1) after completion of the drilling operation through wall (11). The distal end of the cylindrical component (1) protrudes on the opposite side of the wall (11), where the anchoring arrangement (2) is locked inside the wall (11), fixing the cylindrical component (1) in place. FIG. 5 shows the cylindrical component (1) fixed within the wall (11) after the drilling adapter (5) and drilling head (6) are removed. Wall interface (la) extends horizontally relative to the position of the cylindrical component (1) in the wall and fixes it in place. FIG. 6 shows the final result of the cylindrical component (1) fixed inside wall (11). The space (12) opened by the cylindrical component (1) can now accommodate housings of electrical appliances, where the cylindrical component (1) is configured to directly or indirectly couple with such housings. FIG. 4 shows an exploded view of the entire arrangement of cylindrical component (1), drilling adapter (5) and drilling head (6) after drilling operation is completed and suitable space (12) is cleared within wall (11).

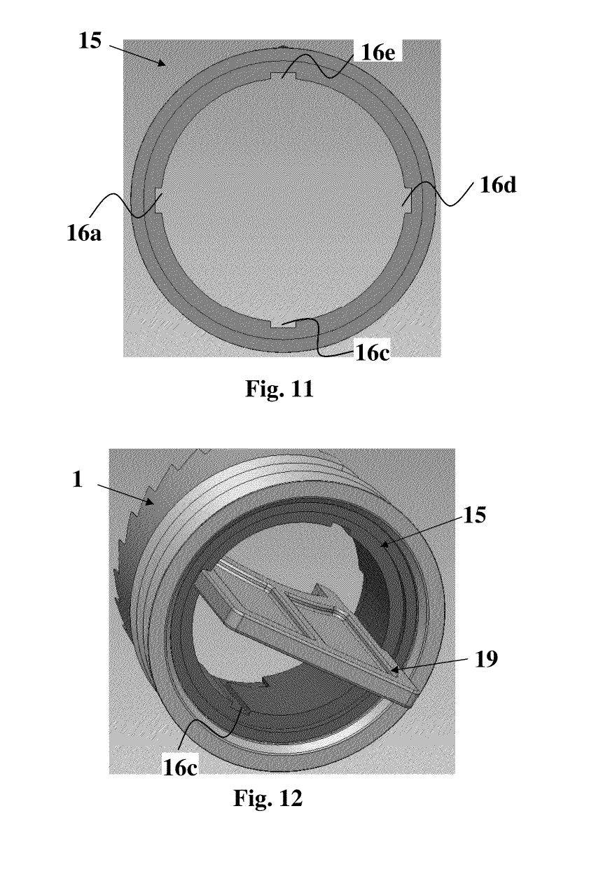

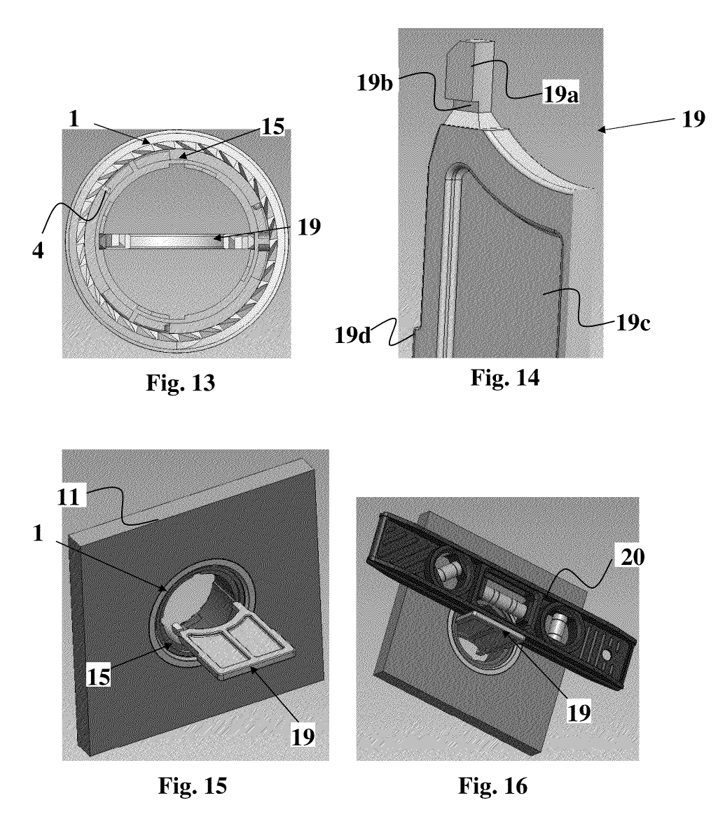

As mentioned above, certain electrical appliances require particular orientation in space. When introduced into a suitable housing, they require a supplemental adapter to mediate between their housing and the cylindrical component. FIGS. 10-15 illustrate different aspects of such supplemental adapter and accessories to operate it properly. FIG. 10 is a perspective view of adapting ring (15) configured to couple with the cylindrical component (1) (see, for example, FIG. 12). For coupling with the cylindrical component (1), the adapting ring (15) comprises an arrangement of horizontal bars (17a, 17b) at the outer surface of the adapting ring (15), each horizontal bar is spaced apart from a neighbor horizontal bar and blinded by vertical bars (17c, 17d for 17a for example). The horizontal bars (17a, 17b) and vertical bars 17c, 17d for 17a for example) define open channels for accommodating tool interfaces (4) under the vertical bars and movement thereof between two vertical bars. Thus, they enable reversible coupling of the adapting ring (15) with the cylindrical component (1) and allow limited movement of the tool interfaces (4) in the inner surface of the cylindrical component (1), when the adapting ring (15) is introduced into the cylindrical component (1) and coupled with it. This is best illustrated in a cross section of the coupling of the adapting ring (15) within the cylindrical component (1) in FIG. 13. Returning to FIG. 10, the adapting ring (15) comprises L-shaped channels (16a) at the inner surface of the adapting ring (15). These channels (16a) comprise vertical ingress allowing introduction and horizontal retention portion (16b). The ingress of the channels (16a) allows coupling an adapting card (19), as best seen in FIG. 12, to the adapting ring (15), and orienting the ring (15) to a desired position by the partial rotation of the adapting card (19), which causes the adapting ring (15) to rotate. In general, the concept underlying the components and coupling of the present invention aim at minimal employment of screws. The screw (18a) and hole (18b) arrangement in the adapting ring (15) is used to better lock the ring (15) by friction to the cylindrical component (1). FIG. 11 shows a bottom view of the adapting ring (15). The channels (16a, 16c, 16d and 16e) are oppositely positioned pairs, thus enabling the coupling with adapting card (19).

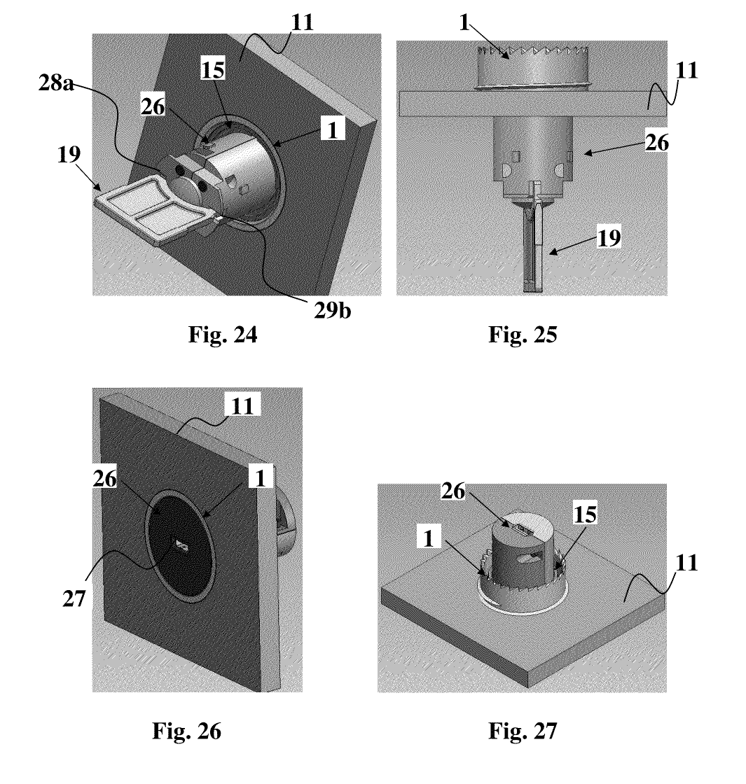

The adapting card (19) comprises several parts necessary for its operation as depicted in FIG. 14. Spikes (19a), one at each side of the distal end of the card (19) are introduced into the matching ingresses (16a) of the adapting ring (15) at opposite positions. Bumpers (19d), extending from opposite sides of the card (19), stop the card (19) from sliding through the adapting ring (15) along the vertical ingresses of the channels (16a). Dents (19b) beneath each spike (19a) are oriented 90° relative to bumpers (19d) and lock the card (19) to housing (26 in FIGS. 24-25) of electrical appliance when introduced into and coupled with the adapting ring (15). The plates (19c) of the adapting card (19c) are used for convenient hold of the card and its manual rotating. FIGS. 14-15 illustrate the coupling and orientation of the adapting card (19) inside the adapting ring (15). A spirit level (20) may be used to confirm that the adapting card (19) is in balanced position, indicating that the adapting ring (15) is properly oriented within the cylindrical component (1). After the adapting card (19) rotates the adapting ring (15) into locked position, it is pulled away by sliding it out of the ingresses of two of the opposite channels it occupies, for example (16c, 16e, or 16a and 16d in FIG. 11). In general, the width of the plate (19c) of the adapting card (19) has a width which is compatible with the diameter of the adapting ring (15) in order to enable proper insertion and friction at the same time that will enable rotating the adapting ring (15) within the cylindrical body (1).

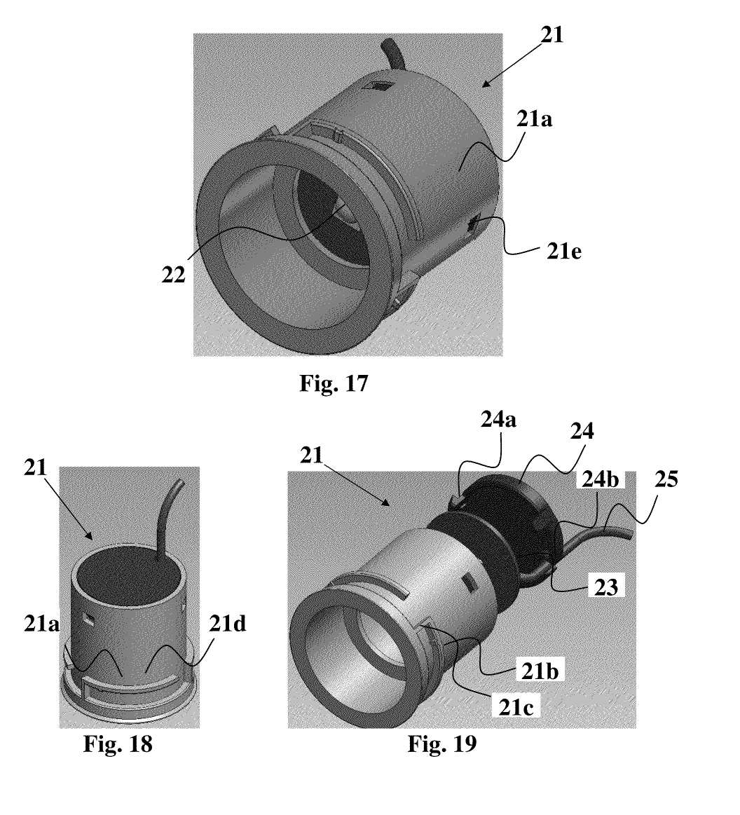

The third component of the invention is the housing for electrical appliances. FIGS. 17-21 and FIGS. 22-27 illustrate two types of housing for electrical appliances, one configured for direct coupling with the cylindrical component (1) and the second indirectly using adapting ring (15). FIGS. 17-21 show an example of housing (21) accommodating light bulb (22). The housing (21) comprises cylindrical body (21a), which is sufficiently spacious to contain the light bulb (22) and with such length suitable to be introduced into the cylindrical component (1). FIG. 18 shows the housing (21) in closed configuration. FIG. 19 shows the same housing (21) as in FIG. 18 in exploded view. L-shaped bars (21d) laid 90° clockwise relative to their vertical position at the proximal end of the outer surface of the cylindrical body (21a) of the housing (21) comprise vertical and horizontal sides (21b, 21c, respectively). These bars define open channels, into which tool interfaces (4) at the inner surface of the cylindrical component (1) may glide, coupling the housing (21) to the cylindrical component (1) and reversibly locking it in place. Cover (24) closes the distal end of housing (21) with clamps (24a) introduced into openings (21e) proximal to the distal end of housing (21). The light bulb (22) is embedded in plate (23) with electrical wire (25) extending outward and passing through a recess (24b) at the perimeter of cover (24). In combining the different parts of housing (21), plate (23) is placed on the distal opening of the housing (21) and held in place with the locking of cover (24) on it.

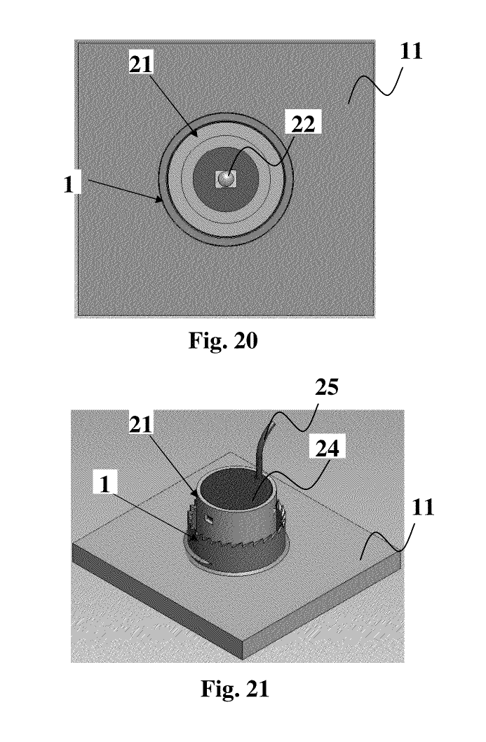

FIGS. 20-21 illustrate the final result of coupling housing (21) of the light bulb (22) with the cylindrical component (1) fixed within a wall (11). FIG. 20 shows a bottom view of this coupling, resulting in the light bulb (22) actually embedded within the wall (11). Such modular configuration enables decoupling the housing (21), replacing the light bulb (22) with any other light bulb or electrical appliance as desired and re-coupling the housing with the cylindrical component (1). This exemplifies the universal concept of the housing for electrical appliances underlying the present invention. FIG. 21 shows the back side of the coupling of the housing (21) within the cylindrical component (1) fixed within a wall (11). The wire (25) extends out of the cover (24) and may be conveniently connected to and disconnected from the grid.

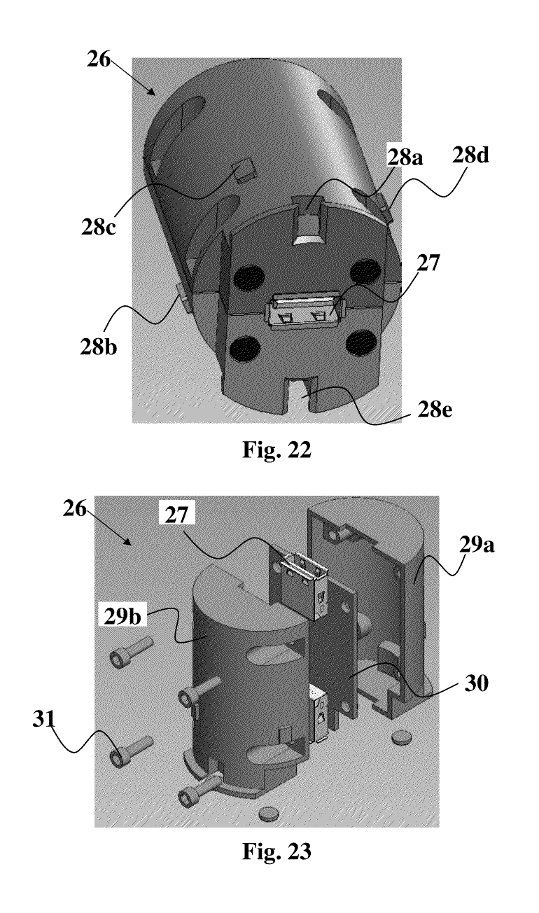

FIGS. 22-27 exemplify a second type of housing for electrical appliance, which require particular orientation. A USB device (27) introduced into the housing (26) is required to be positioned horizontally. Accordingly, the housing is coupled within adapting ring (15), which is coupled within the cylindrical component (1). After coupling the housing (26) within the adapting ring (15), which is coupled to a cylindrical component (1) fixed within a wall (1) (see FIGS. 24-25 in particular), the housing (26) may further be adjusted to horizontal position, for example, by coupling protrusions (28b, 28c, 28d) on the outer surface of the housing (26) with the channels (16a, 16e, 16d) at the inner surface of the adapting ring (15). The protrusions (28b, 28c, 28d) slide through the ingresses of the channels (28b, 28c, 28d), then reversibly lock at the retention portions of these channels by rotating the housing (26) around its horizontal axis. As illustrated in FIGS. 24-25 the rotation of housing (26) may be enabled by coupling with adapting card (19) to recesses (28a, 28e) at the proximal perimeter of the housing (26). The spikes (see element 19a in FIG. 14) of the adapting card (19) reversibly lock to the recesses (28a, 28e) in the housing (26) enabling manual rotation of the card (19). The pressure applied by a user during rotation keeps the card (19) in locked position, the dents (19b) beneath the spikes (19a) serving as level barriers from gliding the card (19) along the outer surface of the housing (26).

The final coupling configuration of the housing (26) within the adapting ring (15) and the adapting ring (15) within the cylindrical component (1), fixed within a wall (11) is best illustrated in FIGS. 26-27 in front and rear perspective views. The USB device (27) is oriented horizontally within the space defined by the cylindrical component (1), where the body of its housing (26) is concealed behind the wall (11). Again here, all couplings of the different components to each other are reversible and the housing (26) may be decoupled and replaced with another housing that accommodates a different electrical appliance. Furthermore, the housing (26) itself may be reused by disintegrating it to its parts and replacing the particular appliance accommodated therein with a different appliance. This is best visualized in the exploded view of the housing (26) in FIG. 23. The top and bottom halves of the cylinder body (29a, 29b) of the housing (26) are departed from each other by releasing screws (31). The plate (30) on which the USB device (27) is placed is removed and replaced or the USB device (27) itself can be removed and replaced with another device using the same plate (30). Afterwards the parts of the housing (26) are integrated again with each other, and the housing (26) may then be re-coupled within the adapting ring (15) using the same method described above.

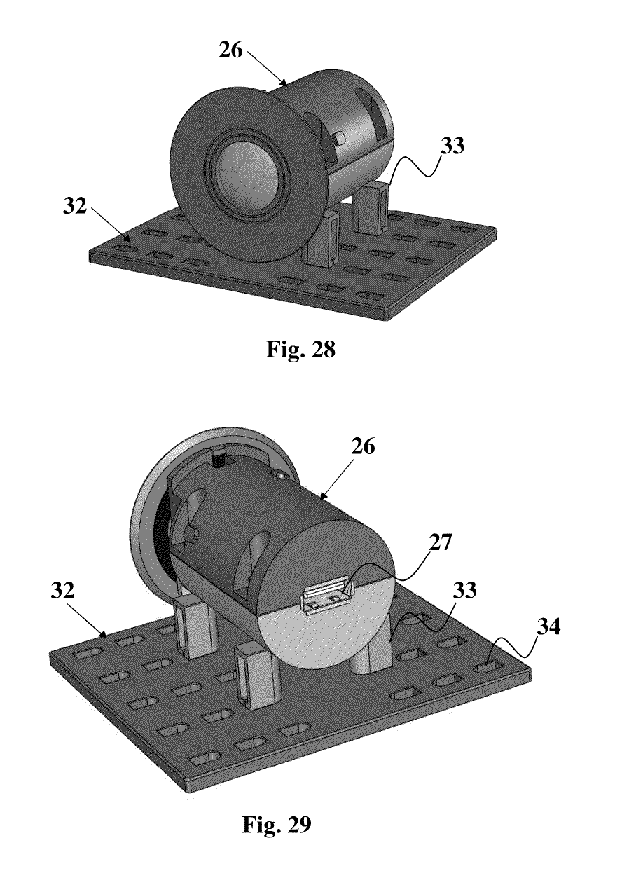

FIGS. 28-29 illustrate a universal plate (32) comprising a plurality of recesses (34) that couple with lifting blocks (33) on which housing (26) is placed, the recesses on the outer surface of the housing (26) are reversibly coupled with the lifting blocks (33). This universal plate (32) frees the user hands from holding the housing (26) and enables disintegrating and regrouping it as discussed above in a convenient manner.

Those skilled in the art to which this invention pertains will readily appreciate that numerous changes, variations and modifications can be made without departing from the scope of the invention mutatis mutandis.

1. Universal housings configured to accommodate a plurality of types of electrical appliances comprising:
cylindrical component configured to drill through and fix to a construction part of a building, said cylindrical component creating a space within said construction part of a building, said space is configured to accommodate an electrical appliance;
and
a housing configured to reversibly couple directly or indirectly within said cylindrical component and accommodate said electrical appliance.

2. The universal housing of claim 1, wherein said cylindrical component comprising:
a cylindrical body;
means configured to define said space by directly drilling said cylindrical component into a construction part of a building;
anchoring arrangement protruding from an outer surface of said cylindrical body and configured for stronger hold of said cylindrical component to said construction part of a building;
wall interface extending horizontally relative to said cylindrical body and configured to fix said cylindrical component in place; and
one or more tool interfaces for reversible coupling with and locking to said drilling means and housing of said electrical appliance.

3. The universal housing of claim 2, wherein said means configured to define said space within said construction part of a building comprising a serrated edge at a distal perimeter of said cylindrical body, wherein serrations at said distal perimeter are configured to have sufficient resistance and strength to drill into said construction part of a building.

4. The universal housing of claim 2, wherein said anchoring arrangement protrudes from an outer surface of said cylindrical body in proximity to a proximal edge of said cylindrical body, said anchoring arrangement is in the form of a left-hand screw.

5. The universal housing of claim 2, wherein said tool interface is in the form shallow cylindrical members, comprising a low cylindrical member protruding from an inner surface of said cylinder body and a flat top side parallel to said inner surface of said cylinder body.

6. The universal housing of claim 5 comprising a plurality shallow cylindrical members evenly circumferentially distributed around said inner surface of said cylinder body and disposed at the same axial locations as one another, said cylindrical members are substantially identical to one another.

7. Drilling means configured to couple within a cylindrical component of a universal housing and drill a pilot hole in a space defined by said cylindrical component within a construction part of a building, said drilling means comprising:
drilling adapter configured to couple to and lock within said cylindrical component;
and
drilling head configured to couple to and lock within said drilling adapter.

8. The universal housing of claim 7, wherein said drilling adapter comprises:
L-shaped channels configured to reversible couple and lock to said tool interfaces of said cylindrical component;
a hollow cubic space within said drilling adapter configured to accommodate a cubic fitting head of said drilling head; and
clamps in opposite sides of said hollow cubic space, said clamps are configured to lock said cubic fitting head down within said hollow cubic space.

9. The universal housing of claim 7, wherein said drilling head comprising:
a drill bit comprising a limited number of twists;
a smooth part continuous with said drill bit;
a cubic fitting head continuous with said smooth part and configured to be inserted within a cubic space within said drilling adapter; and
a shank continuous with said cubic fitting head.

10. The universal housing of claim 1, wherein said housing of electrical appliance comprising:
a cylindrical body configured to accommodate an electrical appliance;
L-shaped bars laid 90° clockwise relative to their vertical position at a proximal end of an outer surface of said cylindrical body of said housing, said bars defining open channels configured to reversibly couple with said tool interfaces of said cylindrical component;
openings in proximity to a distal end of said cylindrical body;
a cover comprising clamps configured to couple to said openings and close said distal end of said cylindrical body and a recess configured to enable passage of electrical wiring connected with an electrical appliance; and
a plate positioned beneath said cover and configured to accommodate said electrical appliance,
said housing of electrical appliance is configured to couple directly to said cylindrical component.

11. The universal housing of claim 1, wherein said housing of electrical appliance comprising:
a cylindrical body;
coupling protrusions on the outer surface of said cylindrical body of said housing and configured to reversibly couple with channels at an inner surface of an adapting ring;
top and bottom halves of said cylinder body of said housing configured to depart from each other;
screws connecting said top and bottom halve to each other; and
a plate within said cylindrical body and configured to carry said electrical appliance.

12. The universal housing of claim 1, further comprising adapting ring configured to reversibly couple within said cylindrical component, said adapting ring comprising:
horizontal and vertical bars at the outer surface of said adapting ring, said bars defining open channels for accommodating said tool interfaces of said cylindrical component; and
L-shaped channels at the inner surface of said adapting ring, said L-shaped channels comprising vertical ingress and horizontal retention portion,
wherein said adapting ring is configured to reversibly and indirectly couple a housing of electrical appliance to said cylindrical component.

13. The universal housing of claim 12, further comprising adapting card configured to reversibly couple to said adapting ring, said adapting card comprising:
a plate defining a body of said adapting card and configured with a width compatible with a diameter of said adapting ring;
spikes at each side of an upper edge of said adapting card;
dents beneath each of said spikes; and
bumpers extending outwardly from side edges of said plate at a lower edge of said plate,
wherein said side edges of said plate are configured to slide through said ingresses of said L-shaped channels of said adapting card, said bumpers are configured to prevent gliding of said adapting card through said adapting ring, said adapting card is configured to rotate said adapting ring within said cylindrical component,
wherein said spikes are configured to reversibly lock to said housing of electrical appliance, said adapting card is configured to rotate said housing of electrical appliance within said adapting ring.

14. The universal housing of claim 1, further comprising a universal plate configured to reversibly lock to housing of electrical appliance, said universal plate comprising:
a plurality of recesses; and
lifting blocks configured to couple to said recesses and recesses at the outer surface of said housing of electrical appliance.

15. A kit for installing electrical appliances in a construction part of a building, wherein said the kit comprising:
cylindrical component configured to define a space within a construction part of a building and reversibly couple and lock to housings of electrical appliances;
housing for electrical appliances configured to accommodate an electrical appliance and reversibly couple within and lock to said cylindrical component;
drilling adapter configured to couple within and lock to said cylindrical component;
and
drilling head configured to couple within and lock to said drilling adapter.
